(19) United States
(12) Patent Application Publication
(10) Pub. No.: US 2017/0164418 A1
(43) Pub. Date: Jun. 8, 2017

(54) METHOD AND SYSTEM FOR NETWORK SETTING OF CONNECTED DEVICE

(71) Applicant: Acer Incorporated, New Taipei City (TW)

(72) Inventors: Chuan-Ming Tsai, New Taipei City (TW); Chun-Hua Lee, New Taipei City (TW); Chun-Liang Lin, New Taipei City (TW)

(73) Assignee: Acer Incorporated, New Taipei City (TW)

(21) Appl. No.: 15/357,657

(22) Filed: Nov. 21, 2016

(30) Foreign Application Priority Data
Dec. 7, 2015 (TW) 104140961

(51) Int. Cl. H04W 76/02; H04L 29/08; H04L 12/24; H04W 8/00

(52) U.S. Cl. CPC H04W 76/023; H04W 76/021; H04W 8/005; H04L 67/306; H04L 41/0813

(57) ABSTRACT

A method and a system for network setting of a connected device, adapted for an electronic apparatus to assist the connected device in setting the network, are provided. In the method, a wireless communication module of the connected device is activated to enable a discoverable state of the connected device. A corresponding wireless communication module of the electronic apparatus is activated to detect the connected device, receive communication information provided by the connected device, and accordingly establish a communication channel between the electronic apparatus and the connected device. The electronic apparatus transmits network setting data to the connected device through the communication channel. The connected device applies the network setting data so as to connect the network.

### CROSS-REFERENCE TO RELATED APPLICATION

This application claims the priority benefit of Taiwan application serial no. 104140961, filed on Dec. 7, 2015. The entirety of the above-mentioned patent application is hereby incorporated by reference herein and made a part of this specification.

### BACKGROUND OF THE INVENTION

Field of the Invention

The invention relates to a method and an apparatus for setting a network, and more particularly to a method and a system for network setting of a connected device.

Description of Related Art

Internet of things (IoT) is a technique based on Internet, which disposes an exclusive electronic tag on an electronic device or any other item through technologies such as radio frequency identification (RFID), and connects those devices or items to Internet for data transmission through communication technologies such as wireless fidelity (Wi-Fi), global system for mobile communication (GSM), wideband code division multiple access (WCDMA), or long term evolution (LTE), such that those devices or items may communicate with each other through the Internet and provide management functions for other devices connected to the Internet to track or monitor them.

Although the connected devices have network connecting capability, they require the user to set up the network in the first use. However, different from smartphones or laptops, some connected devices like webcams, smart appliances, or smart switches may not be equipped with a display, and even not equipped with physical buttons for user's operation. Therefore, how to connect the connected devices to the network is an inevitable issue encountered after the user purchases them.

For those connected devices not equipped with a display, current solutions adopt a Wi-Fi protected setup (WPS) technique to automatically connect the connected devices with other devices that can provide network access so as to connect the network through those devices. Taking a router as an example, the user is required to activate the WPS function of the connected device (e.g. turning on the power or pressing a WPS button), and press the WPS button on the router, such that the two devices may establish a connection automatically. Finally, the connected devices may connect the network through the router.

However, although the WPS technique provides a convenient way for the user to establish the connection, in the process of establishing the connection, a personal identification number (PIN) of the device is required to be transmitted without encryption. Therefore, there is a risk that the PIN may be stolen by others. Moreover, the WPS technique requires disposing an additional button on the device for activating the WPS function, which also increases the manufacture cost of the device.

### SUMMARY OF THE INVENTION

The invention provides a method and an apparatus for network setting of a connected device, through which the connected device can be set to connect the network automatically while security of the data stored in the connected device can be ensured.

The method for network setting of a connected device according to the invention is adapted for an electronic apparatus to assist the connected device in setting the network. In the method, a wireless communication module of the connected device is activated to enable a discoverable state of the connected device. A corresponding wireless communication module of the electronic apparatus is activated to detect the connected device, receive communication information provided by the connected device, and accordingly establish a communication channel between the electronic apparatus and the connected device. Then, the electronic apparatus transmits network setting data to the connected device through the communication channel. Finally, the connected device applies the network setting data to connect the network.

The system for network setting of a connected device according to the invention includes a connected device and an electronic apparatus. The connected device includes a wireless communication module which can be activated to enable a discoverable state of the connected device. The electronic apparatus includes a network module and a wireless communication module, in which the network module has connected the network in advance and the wireless communication module searches for the connected deice, receives communication information provided by the connected device, and accordingly establishes a communication channel between the electronic apparatus and the connected device. The electronic apparatus may transmit network setting data for connecting the network to the connected device through the communication channel and the connected device may apply the network setting data to connect the network.

Based on the above, the method and the system for network setting of a connected device according to the invention activate a discoverable state of the connected device such that the electronic apparatus located nearby and connected with the network may find the connected device and establish a communication channel with the connected device. The electronic apparatus may further provide setting data associated with network connection to the connected device such that the connected device may apply the data directly to connect the network. Accordingly, not only the security of data can be ensured during the network setting process, but the cost of the additionally disposed physical button can be saved.

To make the above features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate examples of the invention and, together with the description, serve to explain the principles of the invention.

FIG. 1 is a block diagram of a system for network setting of a connected device according to an embodiment of the invention.

FIG. 2 is a flowchart illustrating a method for network setting of a connected device according to an embodiment of the invention.

FIG. 3A to FIG. 3E illustrate an example of a method for network setting of a connected device according to an embodiment of the invention.

FIG. 4 is a block diagram of a system for network setting of a connected device according to an embodiment of the invention.

FIG. 5 is a flowchart illustrating a method for network setting of a connected device according to an embodiment of the invention.

FIG. 6A to FIG. 6E illustrate an example of a method for network setting of a connected device according to an embodiment of the invention.

### DETAILED DESCRIPTION OF DISCLOSED EMBODIMENTS

Since the connected device must be equipped with a communication module for connecting the network, the present invention activates such communication module to enable a discoverable state of the connected device. Meanwhile, an electronic apparatus that has been connected to the network in advance is used to search for the connected device, establish a communication channel with the connected device, and transmit setting data required for connecting the network to the connected device. Accordingly, the connected device may complete network setting automatically without additional hardware or additional operations and ensure the security of data during the setting process.

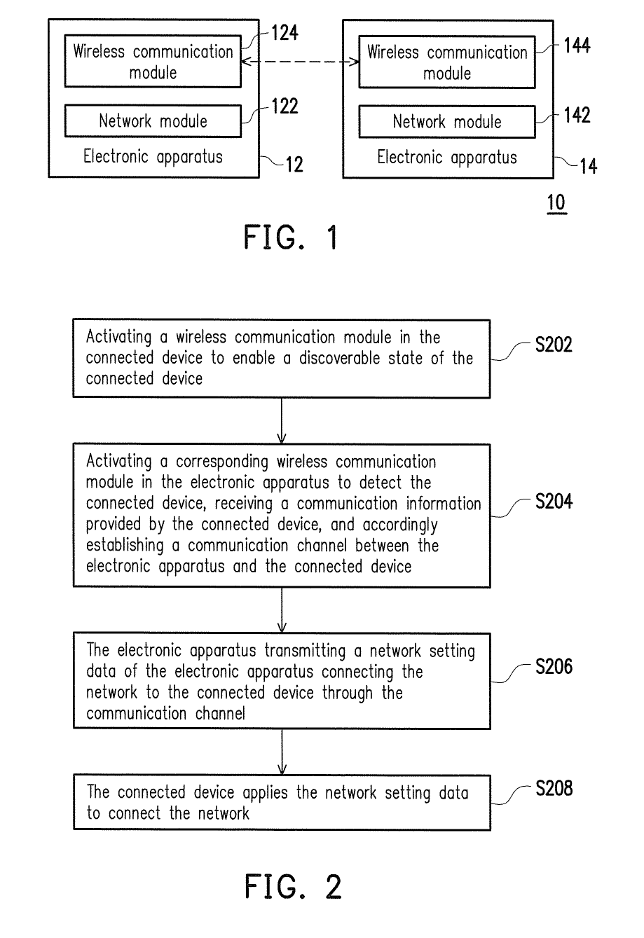

FIG. 1 is a block diagram of a system for network setting of a connected device according to an embodiment of the invention. Referring to FIG. 1, the network setting system 10 of the present embodiment comprises a connected device 12 and an electronic apparatus 14, and functions thereof are respectively described below.

The connected device 12 is, for example, a device or an item in various fields such as smart home, health, traffic, logistics, or electricity. In one embodiment, the connected device 12 comprises a network module 12 and a wireless communication module 124 for supporting functions of network connection and wireless communication. The network module 122 is, for example, a network card or a network equipment that supports Ethernet or wireless network standards such as 802.11g, 802.11n, or 802.11ac. The wireless communication module 124 supports but not limited to at least one of the following wireless transmission techniques: global system for mobile communication (GSM), personal handy-phone system (PHS), general packet radio service (GPRS), code division multiple access (CDMA), wideband code division multiple access (WCDMA), wireless fidelity (Wi-Fi), worldwide interoperability for microwave access (WiMAX), long term evolution (LTE) or Bluetooth. It is noted that, in another embodiment, the network module 122 may be integrated in the wireless communication module 124 such that the connected device 12 may wirelessly connect an external network connecting device (e.g. a router) through the wireless communication module 124 and then connect the network through the external network connecting device.

The electronic apparatus 14 is, for example, a desktop, a laptop, a smartphone, a personal digital assistant (PDA), a tablet PC, or other devices capable of connecting the network. The electronic apparatus 14 is connected to the network in advance so as to provide data associated with network connection to the connected device 12. The electronic apparatus 14 comprises a network module 142 and a wireless communication module 144 corresponding to the wireless communication module 122 of the connected device 12. The network module 142 is, for example, a network card or a network equipment that supports Ethernet or wireless network standards such as 802.11g, 802.11n, or 802.11ac. The wireless communication module 144 supports at least one of aforesaid wireless transmission techniques that are supported by the wireless communication module 124. Similarly, the network module 142 may also be integrated in the wireless communication module 144 such that the electronic apparatus 14 may connect the network directly through the network module 142.

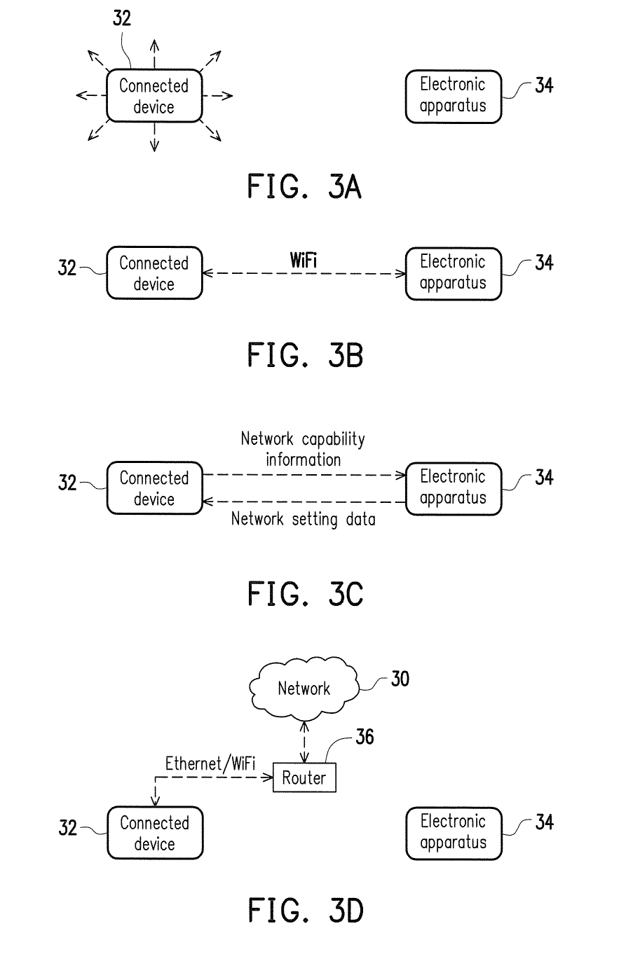

FIG. 2 is a flowchart illustrating a method for network setting of a connected device according to an embodiment of the invention. Referring to FIG. 1 and FIG. 2, the method according to the present embodiment is adapted for the network setting system 10 in FIG. 1. In the following, detailed steps of the method are explained with reference to the elements in the network setting system 10.

First, the wireless communication module 124 of the connected device 12 is activated by a user to enable a discoverable state of the connected device (step S202). In one embodiment, when the user turns on the power of the connected device 12, the connected device 12 may activate the wireless communication module 124 so as to enter a Wi-Fi AP mode, a Wi-Fi direct mode, or a Bluetooth pairing mode. Meanwhile, the connected device 12 is under the discoverable state. In other embodiments, the connected device 12 may provide other manners for activating the wireless communication module 124 to enter the discoverable state such as pressing a specific button or touching a specific area, but the invention is not limited thereto.

On the other hand, the wireless communication module 144 of the electronic apparatus 14 is also activated by the user to detect the connected device 12. The wireless communication module 144 may connect a hotspot established by the wireless communication module 124 or perform Bluetooth pairing with the wireless communication module 124 by using techniques such as multicast domain name system (mDNS), Wi-Fi network address translation (NAT) or Bluetooth pairing. After detecting the connected device 12, the electronic apparatus 14 may receive communication information provided by the connected device 12, and accordingly establish a communication channel between the electronic apparatus 14 and the connected device 12 (step S204).

In detail, the wireless communication module 124 of the connected device 12 may establish a communication server such as a hypertext transfer protocol (HTTP) file server (HFS) complied with HTTP, so as to connect other devices for data transmission. The wireless communication module 124 may use transmission control protocol/internet protocol (TCP/IP), user datagram protocol (UDP) or other high-level communication protocols, so as to establish the communication server, but the invention is not limited thereto.

Correspondingly, the wireless communication module 144 of the electronic apparatus 14 may receive an identification code provided by the connected device 12, so as to connect the communication server established by the connected device 12 by using the identification code and obtain a network address of the connected device 12. The network address is, for example, an Internet protocol address (IP address). The identification code is, for example, a service set identifier (SSID) of the connected device 12 or identification data provided in other forms or formats, but the invention is not limited thereto. Finally, the wireless communication module 144 may search the connected device 12 and establish the communication channel with the wireless communication module 124 of the connected device 12 by using the network address.

It is noted that, in another embodiment, the wireless communication module 144 of the electronic apparatus 14 may connect a local network established by a router (not shown), and search the connected device 12 and establish the communication channel with the connected device 12 by using the network address of the connected device 12. In brief, the communication channel between the connected device 12 and electronic apparatus 14 may be independently established between the two devices or established through the router, but the invention is not limited thereto.

After the communication channel is established, the electronic apparatus 14 may transmit network setting data of the electronic apparatus 14 connecting the network to the connected device 12 through the communication channel established by the wireless communication module 144 (step S206). The connected device 12 then applies the network setting data to connect the network through the network module 122 (step S208). The network setting data may comprise a name, a password, a media access control address (MAC address), a port number, a supported wireless network standard (e.g. 802.11n) of a router that provides that local network. After obtaining the setting data, the connected device 12 may apply the setting data to network setting of the network module 122. In one embodiment, the communication channel between the connected device 12 and the electronic apparatus 14 may be disconnected after the connected device 12 obtains the network setting data. Instead, the connected device 12 and the electronic apparatus 14 may respectively connect the network (e.g. the local network established by the router), and transmit data through the network. In another embodiment, the communication channel may be kept or recovered in any time in response to the user's need.

It is noted that, in one embodiment, the wireless communication module 124 of the connected device 12 may support various network connecting functions such as Wi-Fi, GPRS, 3G, or LTE. Therefore, the wireless communication module 144 of the electronic apparatus 14 may further receive network capability information transmitted by the wireless communication module 124 of the connected device 12 through the established communication channel, in which the network capability information may record the network connecting functions supported by the connected device 12. In another embodiment, the wireless communication module 124 of the connected device 12 may search multiple neighboring devices that can provide the network connecting functions, such as Wi-Fi hotspots, and accordingly add a list of those devices to the network capability information and send the network capability information to the electronic apparatus 14.

After obtaining the network capability information, in one embodiment, the electronic apparatus 14 may display the network connecting functions supported by the connected device 12 on a screen thereof for the user to select the network connecting function to be used, and accordingly provide the network setting data corresponding to the selected network connecting function to the connected device 12, so as to assist the connected device 12 in connecting the network by using the network connecting function. In another embodiment, the electronic apparatus 14 may display the devices capable of providing the network connecting function searched by the connected device 12 on the screen thereof for the user to select the network connecting function to be used and enter a password, so as to assist the connected device 12 in connecting the device and further connect the network through the device. In another embodiment, the electronic apparatus 14 may automatically select the network connecting function or device that supports fastest network speed, best security, or lowest cost, so as to assist the connected device 12 in connecting the network through the network connecting function or the device. Accordingly, the electronic apparatus 14 may preferably provide the setting data required for the connected device 12 to connect the network to the connected device 12, so as to assist the connected device 12 in connecting the network.

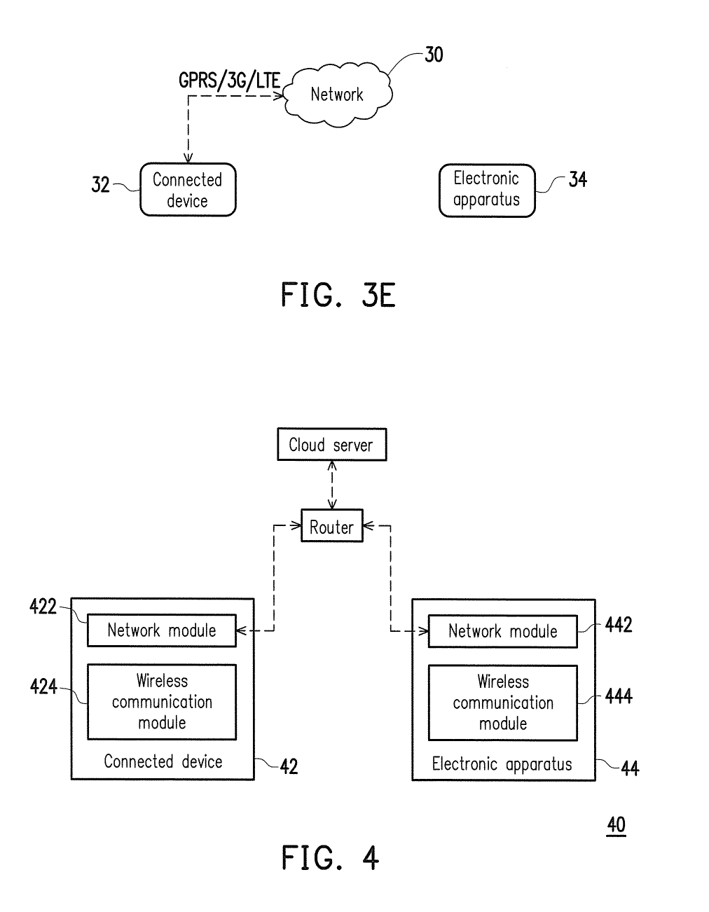

For example, FIG. 3A to FIG. 3E illustrate an example of a method for network setting of a connected device according to an embodiment of the invention. Referring to FIG. 3A first, in the present embodiment, a user activates a Wi-Fi module of a connected device 32 to enable a discoverable state of the connected device 32. Next, referring to FIG. 3B, the user activates a Wi-Fi module of an electronic apparatus 34 to detect the connected device 32, receives communication information provided by the connected device 32, and then establishes a communication channel between the electronic apparatus 34 and the connected device 32. Then, referring to FIG. 3C, the connected device 32 transmits network capability information through the communication channel, so as to inform the electronic apparatus 34 of the network connecting functions supported thereby. If the connected device 32 supports Ethernet or Wi-Fi, as shown in FIG. 3D, the electronic apparatus 34 may provide network setting data used for connecting the router 36 (e.g. an identification or a password of the router 36) to the connected device 32 and disconnect the communication channel between the electronic apparatus 34 and the connected device 32. Accordingly, the connected device 32 may connect the router 36 according to the network setting data, so as to connect the network 30 and the electronic apparatus 34 through the router 36. On the other hand, if the connected device 32 supports GPRS, 3G, or LTE, as shown in FIG. 3E, the electronic apparatus 34 may provide the network setting data used for connecting the network 30 through GPRS, 3G, or LTE to the connected device 32 and disconnect the communication channel between the electronic apparatus 34 and the connected device 32. Accordingly, the connected device 32 may directly connect the network according to the network setting data.

Through aforesaid network setting method, the connected device 12 is able to complete the network setting and then to connect the network with the assistance provided by the electronic apparatus 14 even the connected device 12 is not equipped with a display or a physical button.

It is noted that, beside aforesaid network setting method of the connected device, the present invention may further assist the connected device in loging in a cloud service, so as to implement cloud management functions. Examples are given below for further illustration.

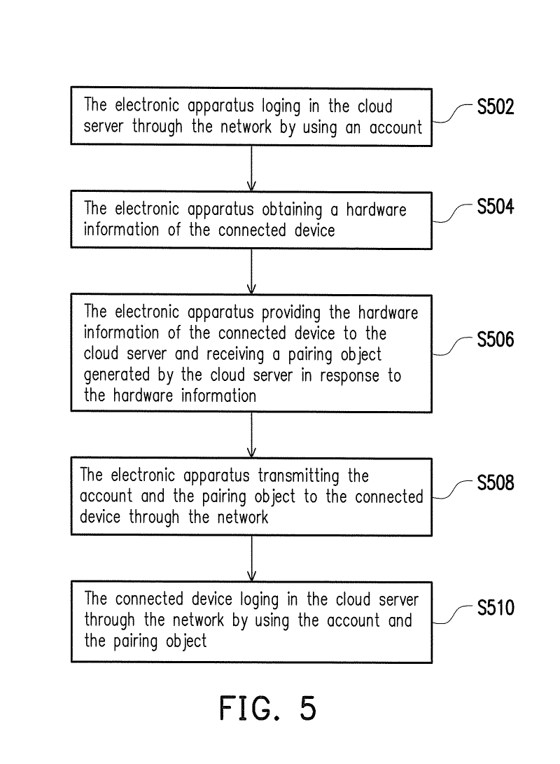

FIG. 4 is a block diagram of a system for network setting of a connected device according to an embodiment of the invention. Referring to FIG. 4, the network setting system 40 comprises a connected device 42, an electronic apparatus 44, a router 46 and a cloud server 48. The connected device 42 comprises a network module 422 and a wireless communication module 424, and the electronic apparatus 44 comprises a network module 442 and a wireless communication module 444 corresponding to the wireless communication module 422 of the connected device 42. Types and functions of the connected device 42 and the electronic apparatus 44 are the same as or similar to those of the connected device 12 and the electronic apparatus 14, and thus the details thereof are not repeated herein.

The router 46 is a network equipment that supports wired network standards such as Ethernet and/or wireless network standards such as 802.11g, 802.11n, or 802.11ac, and is capable of connecting neighboring electronic apparatuses and supporting those electronic apparatuses to connect the Internet. The router 46 is, for example, an edge router that can directly connect the Internet, or a core router that can transmit data with other routers, such as a router of an Internet service provider (ISP), so as to connect the Internet through this router.

The cloud server 48 is, for example, a cloud server selected from a system consisted of a plurality of cloud servers, and provide cloud services such as cloud computing, cloud storage, or cloud backup through the network.

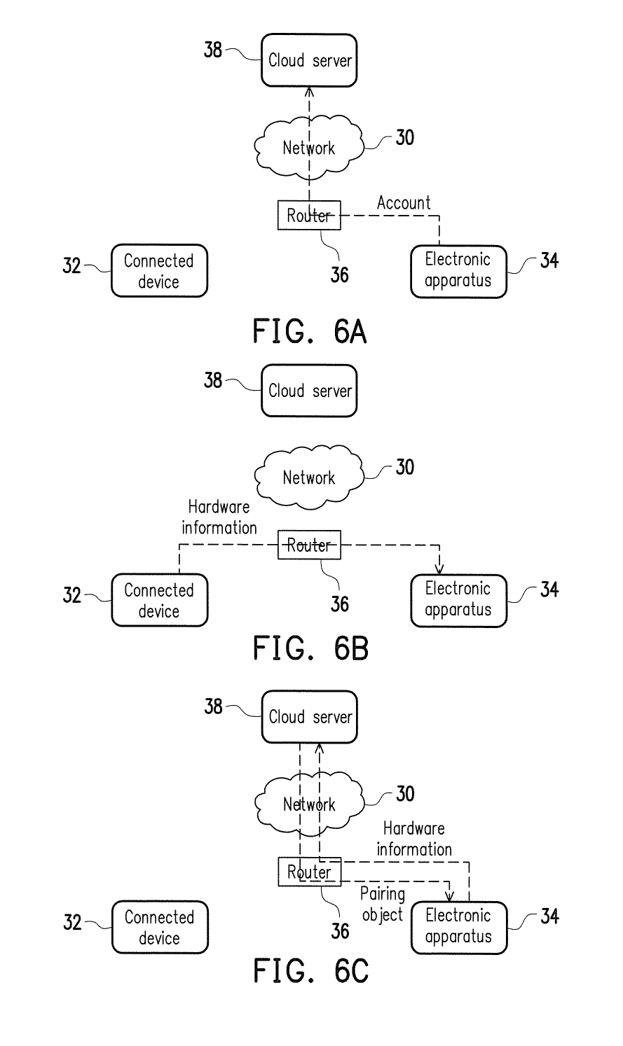

FIG. 5 is a flowchart illustrating a method for network setting of a connected device according to an embodiment of the invention. Referring to FIG. 4 and FIG. 5, the method of the present embodiment is adapted for a situation that the connected device 42 has completed network setting and has connected the network. The network of the connected device 42 is, for example, set and connected through the method as illustrated in FIG. 2, but the present embodiment is not limited thereto. In the following, detailed steps of the method are explained with reference to the elements in the network setting system 40.

First, the electronic apparatus 44 logs in the cloud server 48 through the network by using an account (step S502). In one embodiment, the electronic apparatus 44, for example, connects the router 46 by using the network module 442 and connects the network through the router 46 so as to log in the cloud server 48 through the network. In another embodiment, the electronic apparatus 44 may connect the network through wireless communication manners such as GPRS, 3G, or LTE by using the wireless communication module 424. Besides, the aforesaid account is registered by the user for using the cloud service, such that when the electronic apparatus 44 logs in the cloud server 48 by using the account, the user may use the electronic apparatus 44 to manage other devices that use the same account to log in the cloud server 48 through the cloud service.

Next, the electronic apparatus 44 obtains hardware information of the connected device 42 (step S404). The hardware information is, for example, a serial number (S/N) of the electronic apparatus 44, or exclusive identification information such as MAC address of a network card or other devices in the electronic apparatus 44, which can provide other devices to recognize the electronic apparatus 44.

It is noted that, in one embodiment, the network module 422 of the connected device 42 may, for example, broadcast connection information thereof on the local network established by the router 46, such that other electronic devices located on the same local network may find and connect the connected device 42 by using mDNS. In one embodiment, the connection information broadcasted by the network module 422 is, for example, an IP address and/or an IP port assigned by the router 46. In another embodiment, the information broadcasted by the network module 422 may further include a specific service type, so as to correspond the network setting service provided by the present embodiment. Accordingly, the electronic apparatus 44 supporting this service may send a request including such service type to the network module 422 of the connected device 42, so as to establish a connection with the connected device 42 and obtained the required hardware information. It is noted that, in another embodiment, the electronic apparatus 44 may obtain the hardware information of the connected device 42 through the communication channel established by the wireless communication module 444 and the wireless communication module 424 of the connected device 42.

Then, the electronic apparatus 44 provides the hardware information of the connected device 42 to the cloud server 48 and receives a pairing object generated by the cloud server 48 in response to the hardware information (step S406). The pairing object is, for example, a pairing token specialized for the connected device 42, and can only be used by the connected device 42 to log in the cloud server 48.

Afterward, the electronic apparatus 44 transmits the account and the pairing object obtained from the cloud server 48 to the connected device 42 through the network (step S408), such that the connected device 42 may log in the cloud server 48 through the network by using the account and the pairing object (step S410). Accordingly, the user may use the electronic apparatus 44 to execute management functions such as tracking or monitoring on the connected device 42 through the cloud service.

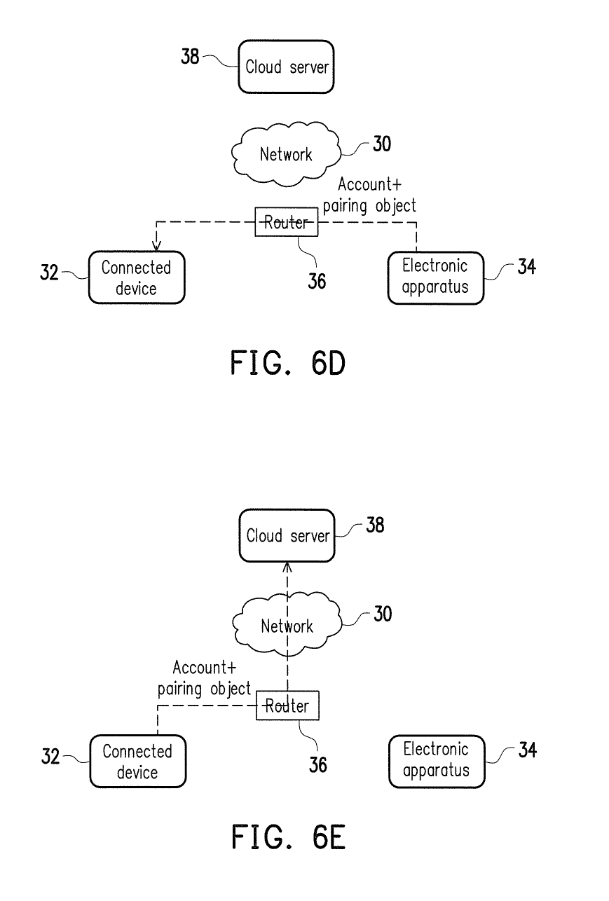

For example, FIG. 6A to FIG. 6E illustrate an example of a method for network setting of a connected device according to an embodiment of the invention. Referring to FIG. 6A, the present embodiment is performed after the process in FIG. 3D, that is, the connected device 32 has connected network 30 and the electronic apparatus 34 through the router 36. At this time, the electronic apparatus 34 connects the network 30 through the router 36 and logs in the cloud server 38 through the network 30 by using the registered account. On the other hand, referring to FIG. 6B, the connected device 32 broadcasts the connection information thereof on the local network established by the router 36, and the electronic apparatus 34 receives the connection information broadcasted by the connected device 32 through the local network and connects the connected device 32 to obtain the hardware information of the connected device 32 according to the connection information. Then, referring to FIG. 6C, the electronic apparatus 34 connects the network 30 through the router 36, and provides the hardware information to the cloud server 38 through the network 30. When receiving the hardware information of the connected device 32, the cloud server 38 generates a pairing object in response to the hardware information and transmits the pairing object back to the electronic apparatus 34. Afterward, referring to FIG. 6D, the electronic apparatus 34 transmits the pairing object along with the account to the connected device 32 through the local network established by the router 36. Finally, referring to FIG. 6E, the connected device 32 connects the network 30 through the router 36 and logs in the cloud server 38 through the network 30 by using the account and the pairing object. Accordingly, the connected device 32 may complete the settings of connecting the cloud server 38.

Returning back to the flow in FIG. 4, it s noted that since the electronic apparatus 44 has obtained the hardware information of the connected device 42 and the connected device 42 has obtained the account of the electronic apparatus 44 loging in the cloud server 48, the electronic apparatus 44 and the connected device 42 may coordinate to encrypt the data transmitted therebetween by using the account. For example, the account may be hashed and used for encrypting the transmitted data. Accordingly, the security of data transmission between the electronic apparatus 44 and the connected device 42 can be ensured.

On the other hand, after loging in the cloud service, the connected device 42 may enter a configurable mode in which the electronic apparatus 44 loging in the same cloud service may change the configuration of the connected device 42. In detail, in one embodiment, the electronic apparatus 44 may transmit a configuration change command to the connected device 42 through the cloud server 48 so as to change a configuration of the connected device 42, such as controlling home appliances, lights, or webcams. In another embodiment, the electronic apparatus 44 may transmit the configuration change command through the communication channel established between the electronic apparatus 44 and the connected device 42. Accordingly, even though the connected device 42 disconnects the network afterwards, the electronic apparatus 44 can still control the connected device 42 through the near filed communication, so as to achieve the functions similar to those provided by the cloud service.

It is noted that, the configuration change command transmitted to the connected device 42 by the electronic apparatus 44 or the data transmitted to the electronic apparatus 44 by the connected device 42 may be encrypted by using aforesaid account, which means in one aspect the account can be used to encrypt the data to be transmitted to an opposite side and in another aspect the account can be used to decrypt the data received from the opposite side. Accordingly, the security of data transmission between the devices can be ensured.

To sum up, in the method and the system for network setting of a connected device of the present invention, a communication channel is established between the connected device and an electronic apparatus that is connected to the network in advance, and the setting data associated with the electronic apparatus connecting the network is provided to the connected device by the electronic apparatus such that the connected device can quickly complete the network setting. Besides, the connected device may obtain the pairing object provided by the cloud server through the electronic apparatus, so as to quickly complete the setting for loging in the cloud server. Accordingly, not only the cost for the additionally disposed buttons can be saved, the security of the data transmission on the network can be ensured through encrypting the transmitted data by the information like the account.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A method for setting a network of a connected device, adapted for an electronic apparatus to assist the connected device in setting the network, wherein the electronic apparatus has connected the network in advance, comprising:
activating a wireless communication module of the connected device to enable a discoverable state of the connected device;
activating a corresponding wireless communication module of the electronic apparatus to detect the connected device, receiving a communication information provided by the connected device, and accordingly establishing a communication channel between the electronic apparatus and the connected device;
transmitting a network setting data of the electronic apparatus connecting the network to the connected device by the electronic apparatus through the communication channel; and
applying the network setting data to connect the network by the connected device.

2. The method according to claim 1, wherein the step of receiving the communication information provided by the connected device, and accordingly establishing the communication channel between the electronic apparatus and the connected device comprises:
receiving an identification code provided by the connected device;
connecting a communication server established by the connected device to obtain a network address of the connected device by using the identification code; and
detecting the connected device by using the network address and establishing the communication channel with the connected device.

3. The method according to claim 2, wherein the step of receiving the communication information provided by the connected device, and accordingly establishing the communication channel between the electronic apparatus and the connected device comprises:
connecting a local network established by a router to search the connected device and establish the communication channel with the connected device.

4. The method according to claim 1, wherein the step of transmitting the network setting data of the electronic apparatus connecting the network to the connected device by the electronic apparatus through the communication channel comprises:
receiving a network capability information transmitted by the connected device through the communication channel by the electronic apparatus, wherein the network capability information records a network connecting function supported by the connected device; and
transmitting a network setting data corresponding to the network connecting function to the connected device through the communication channel by the electronic apparatus.

5. The method according to claim 1, wherein after the step of applying the network setting data to connect the network by the connected device, the method further comprises:
loging in a cloud server through the network by using an account by the electronic apparatus;
obtaining a hardware information of the connected device by the electronic apparatus;
providing the hardware information to the cloud server and receiving a pairing object generated by the cloud server in response to the hardware information by the electronic apparatus;
transmitting the account and the pairing object to the connected device through the network by the electronic apparatus; and
loging in the cloud server through the network by using the account and the pairing object by the connected device.

6. The method according to claim 5, wherein before the step of providing the hardware information to the cloud server by the electronic apparatus, the method further comprises:
connecting a local network established by a router to obtain the hardware information broadcasted by the connected device through the local network by the electronic apparatus.

7. The method according to claim 5, wherein before the step of providing the hardware information to the cloud server by the electronic apparatus, the method further comprises:
obtaining the hardware information of the connected device through the communication channel established with the connected device by the electronic apparatus.

8. The method according to claim 5, wherein after the step of loging in the cloud server through the network by using the account and the pairing object by the connected device, the method further comprises:
transmitting a configuration change command to the connected device through the cloud server by the electronic apparatus to change a configuration of the connected device.

9. The method according to claim 5, wherein after the step of loging in the cloud by using the account and the pairing object by the connected device, the method further comprises:
transmitting a configuration change command to the connected device through the communication channel established with the connected device by the electronic apparatus to change a configuration of the connected device.

10. The method according to claim 5, wherein after the step of loging in the cloud server through the network by using the account and the pairing object by the connected device, the method further comprises:
encrypting data transmitted to each other and decrypting the data received from each other by using the account by the electronic apparatus and the connected device.

11. A system for setting a network of a connected device, comprising:
a connected device comprising a first network module and a first wireless communication module, wherein the first wireless communication module is activated to enable a discoverable state of the connected device;
an electronic apparatus, comprising:
a second network module, configured to connect a network in advance;
a second wireless communication module, configured to detect the connected device, receive a communication information provided by the connected device, and accordingly establish a communication channel between the electronic apparatus and the connected device, wherein
the electronic apparatus transmits a network setting data of the electronic apparatus connecting the network to the connected device through the communication channel; and
the connected device applies the network setting data to connect the network through the first network module.

12. The system according to claim 11, wherein the electronic apparatus comprises receiving an identification code provided by the connected device, connecting a communication server established by the connected device to obtain a network address of the connected device by using the identification code, and detecting the connected device by using the network address and establishing the communication channel with the connected device.

13. The system according to claim 12, further comprising:
a router, configured to establish a local network, wherein the electronic apparatus connects the router through the local network, detects the connected device by using the network address, and establishing the communication channel with the connected device.

14. The system according to claim 11, wherein the electronic apparatus further receives a network capability information transmitted by the connected device through the communication channel and transmits a network setting data corresponding to a network connecting function supported by the connected device to the connected device through the communication channel, wherein the network capability information records the network connecting function.

15. The system according to claim 11, further comprising:
a cloud server, configured to provide a cloud service, wherein the electronic apparatus comprises loging in the cloud server through the network by using an account, providing a hardware information of the connected device to the cloud server, and receiving a pairing object generated by the cloud server in response to the hardware information, and transmitting the account and the pairing object to the connected device through the network, and the connected device comprises loging in the cloud server through the network by using the account and the pairing object.

16. The system according to claim 15, further comprising:
a router, configured to establish a local network, wherein the electronic apparatus further connects the router through the local network and obtain the hardware information broadcasted by the connected device through the local network.

17. The system according to claim 15, wherein the electronic apparatus further obtains the hardware information of the connected device through the communication channel established with the connected device.

18. The system according to claim 15, wherein the electronic apparatus further transmits a configuration change command to the connected device through the cloud server to change a configuration of the connected device.

19. The system according to claim 15, wherein the electronic apparatus further transmits a configuration change command to the connected device through the communication channel established with the connected device to change a configuration of the connected device.

20. The system according to claim 15, wherein the electronic apparatus and the connected device further encrypts data transmitted to each other and decrypts the data received from each other by using the account.
